(19) United States
(12) Patent Application Publication
(10) Pub. No.: US 2014/0209589 A1
(43) Pub. Date: Jul. 31, 2014

(54) GUIDED COMPONENT EXTRACTION SYSTEM AND METHOD

(71) Applicant: ILLINOIS TOOL WORKS LNC., Glenview, IL (US)

(72) Inventors: Yury Shkolnikov, Glenview, IL (US); Stan Piotrowski, Glenview, IL (US); Zinovy Royzen, Glenview, IL (US); Daniel P. McDonald, Glenview, IL (US); Gary Lind, Glenview, IL (US)

(73) Assignee: Illinois Tool Works lnc., Glenview, IL (US)

(21) Appl. No.: 13/754,654

(22) Filed: Jan. 30, 2013

(51) Int. Cl. B23K 9/32; F24F 7/00

(52) U.S. Cl. CPC B23K 9/32; F24F 7/00
USPC 219/137.41; 454/49

(57) ABSTRACT

A component extraction system is designed to remove smoke and airborne components, such as particulate, from a metal working or other application. The system may be compatible with a cart-type base unit or may be incorporated into a fixed or semi-fixed installation that uses a nozzle disposed on a carriage to remove workspace air (e.g., containing smoke and airborne components) away from the metal working application. The carriage may travel along a guide rail disposed adjacent to the metal working application in order to place the nozzle near the source of the metal working components. Further, the carriage may include a positioning system, utilizing sensors, to automatically adjust the location of the nozzle proximate the airborne component source.

### BACKGROUND

This disclosure relates generally to automatic component extraction systems, such as those used for welding, cutting, metal working, and similar applications.

Metal working operations range from cutting, welding, soldering, assembly, and other processes that may generate smoke and airborne components. In smaller shops it may be convenient to open ambient air passages or to use suction or discharge air from fans to maintain air spaces relatively clear. In other applications, cart-type extraction systems are used. In industrial settings, more complex fixed systems may be employed for extracting smoke and airborne components from specific work cells, metal working locations, and so forth.

In general, such systems often include an intake component (e.g., nozzle, hood, aperture, etc.) coupled to a conduit that draws the smoke and airborne components from the worksite to various filters, blowers, air recirculation and exhaust components. The extraction system uses suction air to draw the smoke and airborne components from the immediate vicinity of the metal working operation. Further improvements are needed, however, in extraction systems. For example, it would be desirable for an extraction system to automatically adjust its location in order to improve the efficiency with which the extraction system removes smoke and airborne components from the metal working application.

There is a need, therefore, for improved component extraction systems for welding and similar metal working applications.

### BRIEF DESCRIPTION

The present disclosure provides novel approaches to smoke and airborne component extraction designed to respond to such needs. The systems are particularly adapted for welding, cutting, and similar metal working operations that can generate airborne components (e.g., smoke, gases, and so forth), but also particulate matter. In accordance with certain aspects of the disclosure, a component extraction system includes an air handling system for drawing the components from a metal working application. An air conduit is coupled to the air handling system and conveys the components from the metal working application to the air handling system. Further, a nozzle is coupled to the air conduit. The nozzle is configured to be disposed adjacent to the metal working application and to draw the components into the air conduit. A guide rail is also configured to be disposed adjacent to the metal working application and accommodates a carriage movable along the guide rail. The carriage is coupled to position the nozzle with respect to the metal working application.

In accordance with certain aspects, the disclosure offers a component evacuation system that further includes a positioning system. The positioning system is configured to automatically move the carriage to desired locations along the guide rail during a metal working operation.

In accordance with a further aspect, the disclosure provides a component extraction method including powering an air handling system to draw airborne components from a metal working application and positioning a nozzle adjacent to the metal working application. Further, during a metal working operation, the method includes moving the nozzle along a guide rail to desired positions to extract the airborne components.

### DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of a cart-like component extraction system in accordance with aspects of the present techniques;

FIG. 2 is a perspective view of a carriage portion of a component extraction system utilizing the techniques described herein;

FIG. 3 is a perspective view of the bottom of the carriage, detailing a guide rail and rollers;

FIG. 4 is flow diagram of the control system of the extraction system; and

FIG. 5 is flow diagram of a method of operation of the extraction system.

### DETAILED DESCRIPTION

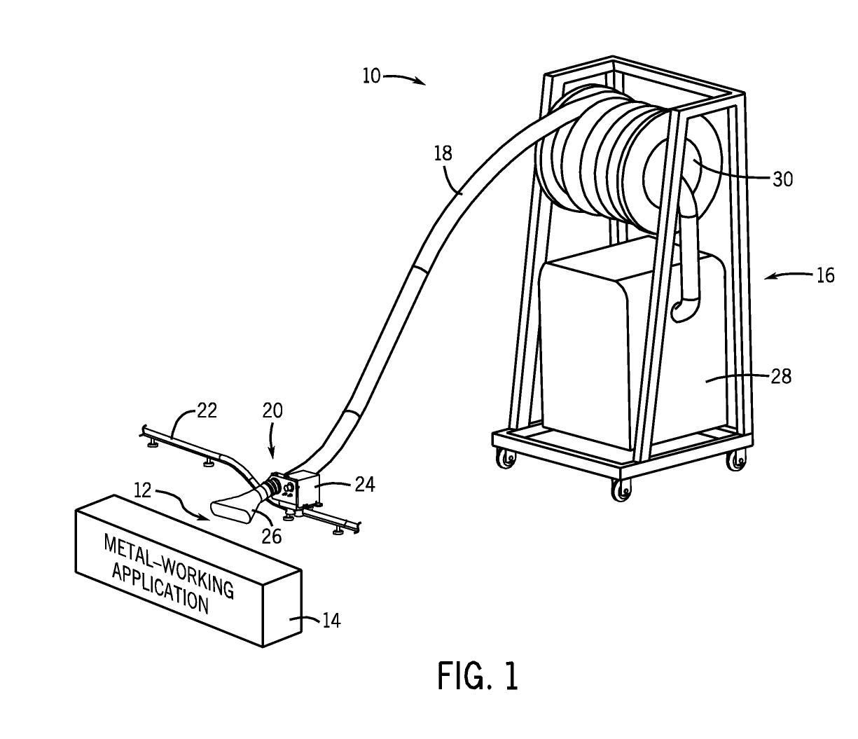

Turning now to the drawings, and referring first to FIG. 1, an extraction system 10 is illustrated for extracting smoke and airborne components, and more generally, workspace air 12 from a metal working or other application 14. In the illustrated embodiment, the extraction system 10 includes a base unit 16 coupled to an air conduit 18 that draws air away from the metal working application 14 using a carriage system 20. The carriage system 20 includes a guide rail 22 that is designed to be placed near the metal working application 14. The guide rail 22 may be modular, such that it can be separated into pieces to be reconfigured into various shapes to accommodate different metal working applications 14. Further, the guide rail 22 may be deformable (e.g., flexible) to accommodate different metal working applications 14. For example, the guide rail 22 may be mounted along a floor, a wall, an incline, a decline, a corner, or a combination thereof. The guide rail 22 may be disposed about the metal working application 14 in a 2D or 3D arrangement.

The carriage system 20 also includes a carriage 24 having a nozzle 26 to draw in the workspace air 12. The carriage 24 moves along the guide rail 22 to ensure the nozzle 26 is close to the metal working application 14, such that a majority of any smoke, particulates, and airborne components may be extracted. In this way, the nozzle 26 provides a source capture feature to maximize airborne component extraction. Extracting the highest possible percentage of the metal working components ensures a clean work environment for the operator, improves overall air quality, and reduces the possibility of further pollution/contamination beyond the metal working application 14. Further, the carriage 24 connects the nozzle 26 to the air conduit 18, which conveys the removed workspace air 12 to the base unit 16. As the base unit 16 is activated, it extracts the workspace air 12 (and any contaminates it contains), directing the extracted air to the base unit 16 for processing.

In the depicted embodiment, the base unit 14 includes a compressor 28 that induces a vacuum for drawing smoke and airborne components in through the nozzle 26. Further, the base unit 16 may include the conduit 18 disposed on a spool 30, such that the length of the conduit 18 can adjust with the location of the carriage 24. However, it should be noted that while described with respect to the stand-alone base unit 16 in certain embodiments, the present disclosure is not limited to this embodiment, and may be used in conjunction with a cart type unit, a fixed installation, or a different physical configuration. More generally, innovations provided by and described in the present disclosure may be implemented into fixed or semi-fixed installations, such as those used in industrial settings. That is, certain components of the base unit 16 described herein may serve multiple workspaces, work cells, weld cells, and so forth, by common conduits 18 that draw air away from multiple metal working applications 14.

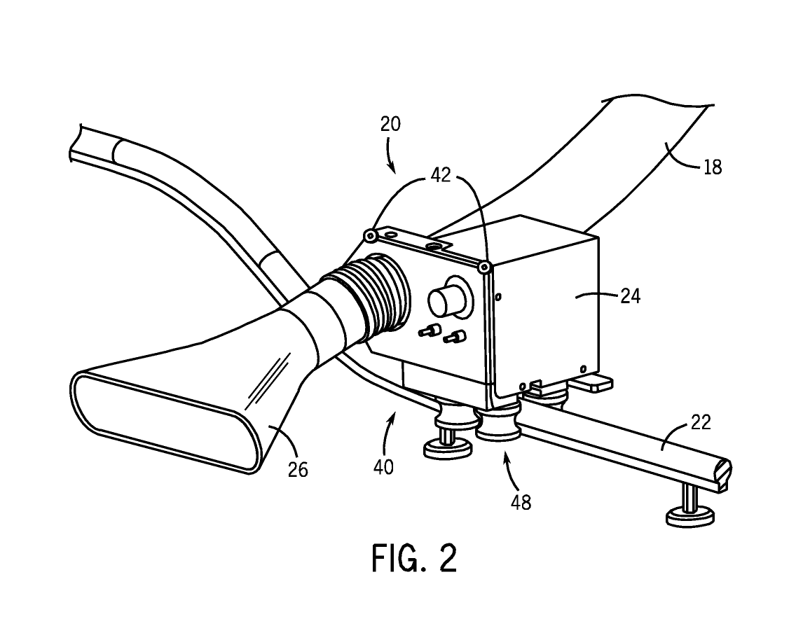

To provide further detail of the workings of the carriage 24 and its additional components, a perspective view of the carriage system 20 is depicted in FIG. 2. For example, it may be advantageous for the carriage 24 to have the ability to automatically adjust its location along the guide rail 22 with respect to the metal working application 14 in order to remove a high percentage of metal working airborne components. Accordingly, the carriage 24 may include a positioning system 40. The positioning system 40 may detect a parameter of the metal working application 14 and adjust the location of the carriage 24 along the guide rail 22, such that the nozzle 36 is disposed adjacent to the metal working application 14 to draw in the airborne components created by the metal working operation. The positioning system 40 may use sensors 42 to detect the parameter of the metal working application 14. The sensors 42 may detect heat, visible light, infrared light, electromagnetic parameters, or other parameters of the metal working application 14. In the depicted embodiment, the positioning system 40 uses two sensors 42, each sensor 42 disposed at a side of the carriage 24. For example, the sensors 42 may detect a weld arc, a concentration of the airborne components, a temperature, or a different parameter of the metal working application 14.

As detailed below, within the carriage 24, the sensors 42 may communicate with a controller 44 and a motor 46. The controller 44 may receive and interpret data from the sensors 42 and then use the data to control the operation of the motor 46. In certain embodiments, the motor 46 may power a roller system 48, which adjusts the location of the carriage 24 along the guide rail 22. Adjusting the location of the carriage 24 (and the associated nozzle 26) with respect to the metal working application 14 may enable the component extraction system 10 having the positioning system 40 to create a high entry coefficient (e.g., high percentage of component removal). Accordingly, improved component extraction may improve the air quality of the welding environment for the operator.

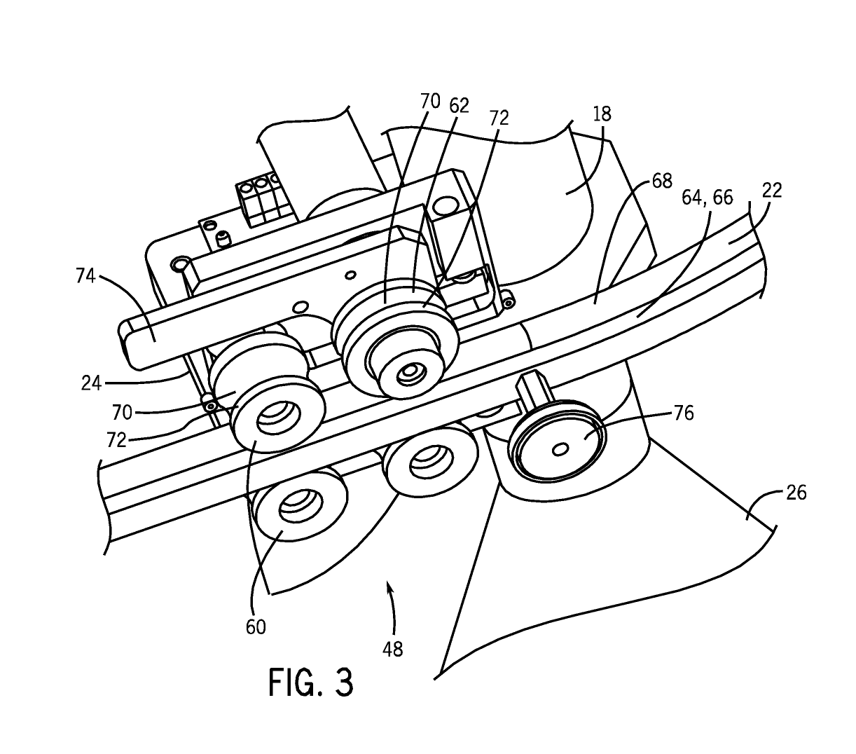

To provide a better understanding of how the roller system 48 interacts with the guide rail 22 to adjust the position of the carriage 24, FIG. 3 depicts a detailed bottom view of the roller system 48. In the depicted embodiment, the carriage 24 is equipped with three rollers 60 and one drive roller 62. The drive roller 62 may be powered by the motor 46 to propel the carriage 24 along the guide rail 22 toward the metal working application 14.

To prevent the drive roller 62 from causing the carriage 24 to rotate about the guide rail 22, the guide rail 22 may include an anti-rotation feature 64. The anti-rotation feature 64 may be a rectangular portion 66 that extends from the bottom of a cylindrical portion 68 of the guide rail 22. Concave portions 70 of the rollers 60 and the drive roller 62 may interface with the cylindrical portion 68 of the guide rail 22. Further, flat portions 72 of the rollers 60 and drive roller 62 may interface with the rectangular portion 66 of the guide rail 22 to prevent rotation of the carriage 24 about the guide rail 22. In this way, the guide rail 22 may be configured in any 2D or 3D arrangement about the metal working application 14 without the carriage 24 dissociating from the guide rail 22.

To enable simple manual placement of the carriage 24 along the guide rail 22, a lever 74 may be coupled to the drive roller 62. The lever 74 may release the drive roller 62 from the guide rail 22 such that the carriage 24 may be moveable along the guide rail 22 when the lever 74 is activated. For example, when an operator is arranging the metal working application 14 prior to commencing the metal working operation, he may depress the lever 74 to position the carriage 24 at an optimal starting position along the guide rail 22.

To add further stability to the guide rail 22 and the carriage 24, the guide rail 22 may include attachment devices 76 to secure the guide rail 22 near the metal working application 14. Such attachment devices 76 may utilize magnets, an adhesive, clamps, or a different attachment method to securely affix and arrange the guide rail 22 around the metal working application 14. The guide rail 22 may include multiple attachment devices 76 along its length, such that the guide rail 22 is securely affixed to the metal working application 14.

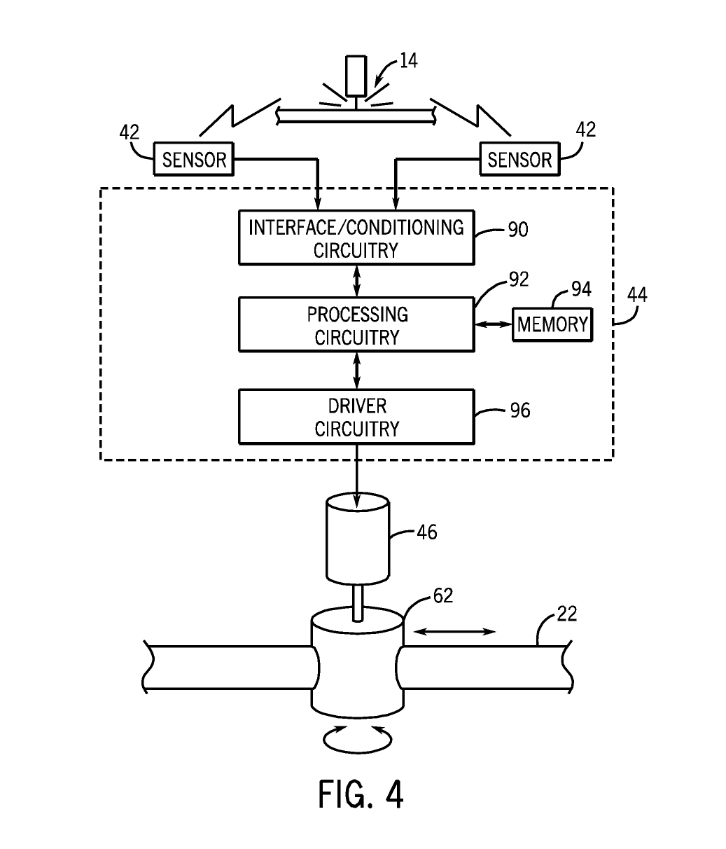

FIG. 4 provides a schematic representation of how the positioning system 40 interacts with the controller 44 to operate the motor 46 and drive roller 62 to adjust the location of the carriage 24 and nozzle 26 with respect to the metal working application 14. As previously described, the sensors 42 may detect a parameter of the metal working operation, such as a weld ark, a temperature, component concentration, etc. As the sensor 42 detects the parameter, it may provide an electronic signal to interface/conditioning circuitry 90 of the controller 44, which may condition the signals from the sensors 42. The conditioned signal may then be conveyed to processing circuitry 92, where the data provided by the sensors 42 may be interpreted by the controller 44. Further, the controller 44 may include memory 94 to store the processed signals provided by the sensors 42. The processed signals may be conveyed to driver circuitry 96, which controls operation of the motor 46 and, thus, the drive roller 62. For example, in an embodiment of the positioning system 40 with two sensors 42 disposed equidistantly from the center of the carriage 24, the controller 44 may direct the drive roller 62 to adjust the location of the carriage 24 until both sensors 42 are providing equal magnitude signals to the processing circuitry 92. In an alternative embodiment, having a single sensor 42 located near the nozzle 26, the controller 44 may direct the drive roller 62 to adjust the location of the carriage 24 until the sensor 42 provides a maximum magnitude signal to the processing circuitry 92. The controller 44 may implement closed-loop or open-loop control schemes to adjust the location of the carriage 24 along the guide rail 22.

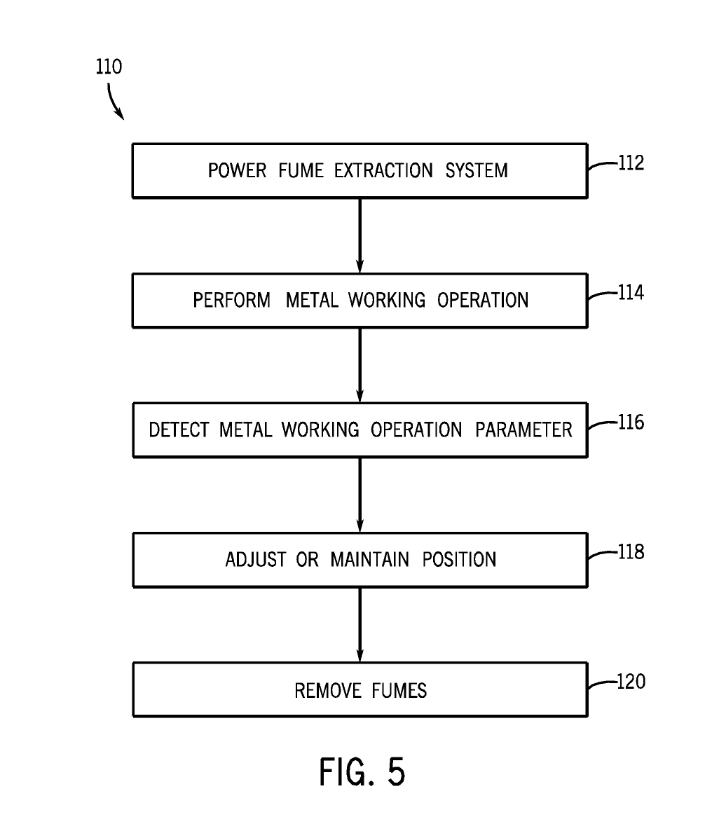

A method 110 of operation of the component extraction system 10 is depicted via flow diagram in FIG. 5. The method 110 includes supplying power to the component extraction system 10, including the positioning system 40, the controller 44, and the motor 46 (block 112). As the metal working operation is performed (block 114), a parameter of the metal working operation is detected by the sensors 42 (block 116). The controller 44 may provide instructions to adjust or maintain the position of the carriage 24 with respect to the metal working application 14 based on signals provided by the sensor(s) 42 (block 118). As the nozzle 26 on the carriage 24 reaches a preferred location, the component extraction system 10 removes any airborne components from the metal working application 14 (block 120) and may convey them to the base unit (or an equivalent setup) for processing.

While only certain features of the disclosure have been illustrated and described herein, many modifications and changes will occur to those skilled in the art. It is, therefore, to be understood that the appended claims are intended to cover all such modifications and changes as fall within the true spirit of the disclosure.

1. A component extraction system comprising:
an air handling system for drawing airborne components from a metal working application;
an air conduit coupled to the air handling system for conveying the airborne components from the metal working application towards the air handling system;
a nozzle coupled to the air conduit and configured to be disposed adjacent to the metal working application to draw the airborne components into the air conduit;
a guide rail configured to be disposed adjacent to the metal working application; and
a carriage movable along the guide rail and coupled to position the nozzle with respect to the metal working application.

2. The system of claim 1, wherein the guide rail comprises a flexible structure that is deformable for positioning around the metal working application.

3. The system of claim 1, wherein the carriage comprises a roller that guides the carriage along the guide rail.

4. The system of claim 3, wherein the guide rail comprises an anti-rotation feature and the roller contacts the anti-rotation feature to prevent rotation of the carriage about the guide rail.

5. The system of claim 1, wherein the carriage is powered to move the nozzle along the guide rail.

6. The system of claim 5, wherein the carriage is closed-loop positionable to move the nozzle to desired positions during a metal working operation.

7. The system of claim 5, wherein the carriage comprises a sensor, a controller, and a motor, the sensor detecting a parameter related to the metal working operation, and the controller receiving signals from the sensor and controlling operation of the motor to move the nozzle to desired positions during a metal working operation.

8. The system of claim 7, wherein the sensor comprises a sensor capable of detecting a welding arc.

9. The system of claim 8, comprising two welding arc sensors, and wherein the controller is configured to receive signals from the welding arc sensors and to control the motor to move the carriage based upon a location of a progressing welding arc.

10. A component extraction system comprising:
an air handling system for drawing airborne components from a metal working application;
an air conduit coupled to the air handling system for conveying the airborne components from the metal working application towards the air handling system;
a nozzle coupled to the air conduit and configured to be disposed adjacent to the metal working application to draw the airborne components into the air conduit;
a guide rail configured to be disposed adjacent to the metal working application;
a carriage movable along the guide rail and coupled to position the nozzle with respect to the metal working application; and
a positioning system configured to automatically move the carriage to desired locations along the guide rail during a metal working operation.

11. The system of claim 10, wherein the positioning system comprises a sensor, a controller, and a motor, the sensor detecting a parameter related to the metal working operation, and the controller receiving signals from the sensor and controlling operation of the motor to move the nozzle to desired positions during a metal working operation.

12. The system of claim 11, wherein the guide rail comprises attachment devices to secure the guide rail adjacent to the metal working application.

13. The system of claim 11, wherein the positioning system comprises two sensors disposed on opposing ends of the carriage.

14. The system of claim 10, the carriage comprising multiple rollers, wherein one of the rollers is a driving roller that is activated by the positioning system to adjust the location of the carriage along the guide rail during the metal working operation.

15. The system of claim 14, wherein the guide rail comprises an anti-rotation feature and the rotors contact the anti-rotation feature to prevent rotation of the carriage about the guide rail.

16. The system of claim 10, wherein the guide rail is formed from multiple segments that are interchangeable for positioning around the metal working application.

17. A component extraction method comprising:
powering an air handling system to draw airborne components from a metal working application;
positioning a nozzle adjacent to the metal working application; and
moving, during a metal working operation, the nozzle along a guide rail to desired positions to extract the airborne components.

18. The method of claim 17, comprising moving the nozzle in a closed-loop manner during the metal working operation.

19. The method of claim 18, comprising sensing a welding arc and automatically moving the nozzle towards the welding arc.

20. The method of claim 19, wherein the nozzle is moved by a carriage disposed on the guide rail, and wherein the carriage comprises a sensor, a controller, and a motor, the sensor detecting the welding arc, and the controller receiving signals from the sensor and controlling operation of the motor to move the nozzle towards the welding arc.
